(19) United States
(12) Patent Application Publication
(10) Pub. No.: US 2005/0033979 A1
(43) Pub. Date: Feb. 10, 2005

(54) Method and system for secure direct memory access

(76) Inventor: Chris D. Hyser, Victor, NY (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/638,008

(22) Filed: Aug. 8, 2003

(51) Int. Cl. H04L 9/00

(52) U.S. Cl. 713/200

(57) ABSTRACT

Method and system that allows a secure processing entity to allocate a portion of a system resource for use only by the secure processing entity. The portion of the system resource allocated for use only by the secure processing entity is protected from DMA-access by an untrusted processing entity, such as an I/O controller in the control of untrusted software. In one embodiment, a secure kernel may provide address translations to a system controller that result in the system controller returning invalid-memory-address errors to a DMA engine attempting to access a portion of a system memory allocated for use only by a secure kernel. In another embodiment of the present invention, a secure kernel initializes a system controller to contain a view of system-memory address space that does not include a portion of system-memory address space allocated for use only by a secure kernel.

### TECHNICAL FIELD

The present invention relates to computer architecture, operating systems, and computer-system security, and, in particular, to a number of methods, and systems employing the methods, for preventing external devices from using direct memory access to maliciously or erroneously access and/or corrupt secure system resources.

### BACKGROUND OF THE INVENTION

Computer security has become an intensely studied and vital field of research in academic, governmental, and commercial computing organizations. While manufacturers and users of computing systems have, for many years, attempted to provide fully secure computer systems with controlled access to stored data, processing resources, and other computational resources within the computer systems, fully secure computer systems currently remain elusive. The need for security has been heightened by public awareness of Internet-related fraud, several high visibility banking-related crimes, and, more recently, the threat of malicious viruses and terrorist-directed cyber assaults.

A fully secure computer needs to be designed on the basis of a comprehensive identification of the myriad different potential vulnerabilities and threats to secure operation of the secure computer system. In general, a fully secure computer system needs to maintain tight security over certain internal resources and isolate and closely monitor external inputs and outputs to insure that external entities, such as external devices, remote computers, and users, cannot access and/or corrupt the internal resources, including portions of system memory within a modern computer system. As computers have evolved to include greater numbers of more complex and capable components, the number of different potential vulnerabilities has greatly increased. Design of fully secure computers is thus a dynamically evolving task that continues to grow in complexity with the evolution of computer hardware. The transfer of data into, and out from, computer systems, for example, involves a set of components that have evolved in ways that increase the potential for unauthorized access of system resources.

FIGS. 1A-D illustrate an initial approach employed within computer systems to transfer data back and forth between internal memory and mass storage devices and communications devices. FIGS. 1A-D employ the same illustration conventions as FIGS. 2A-D and 4A-B, to be discussed below. These illustration conventions are described with respect to FIG. 1A, but will not be repeated in the interest of brevity. FIG. 1A shows important components within a computer system that are involved in input and output (“I/O”) data transfers. In FIG. 1A, a central processing unit (“CPU”) 102, at least one level of cache memory 104, and main memory 106 are interconnected by a system bus 108. In FIG. 1A, an exemplary I/O device, disk drive 110, is controlled by a disk-drive controller 112. The disk-drive controller 112 is connected to an I/O bus 114, to which many additional I/O controllers, not shown in FIG. 1A, may be connected. A bus bridge device 116 interconnects the system bus 108 with the I/O bus 114. Bus bridge devices were initially devised in order to buffer timing and protocol differences between different types of buses, such as the high-speed, synchronous system bus 108 and the lower-speed, asynchronous I/O bus 114.

FIGS. 1B-D illustrate a READ operation initiated by the CPU to READ a block of data from the disk drive to system memory. The CPU 102 initiates the READ operation by controlling signal lines of the system bus 108 to direct a READ operation command to the disk-drive controller 112 via the system bus 108, bus bridge 116, and I/O bus 114. A microprocessor 118 within the I/O controller 112 receives the READ request and, in turn, when the requested data is not resident within an optionally present memory cache within the I/O controller, directs a disk READ request to the disk drive 110 and receives the requested data. Next, as shown in FIG. 1C, the I/O controller 112 transmits the requested data, read from the disk drive, back through the I/O bus 114, bus bridge 116, and system bus 108 to the CPU 102. Finally, as shown in FIG. 1D, the CPU writes the received data to one or both of the cache memory 104 and main memory 106. Of course, many additional details are involved in I/O-data transfers, including data buffering within I/O controllers and system memory, detailed device/control program interfaces, and other such details.

In early computers, the operation illustrated in FIGS. 1B-D was carried out for each word of data moved from the I/O controller 112 to memory 106. I/O data transfer was quickly identified as a bottleneck with respect to system performance, because the CPU devoted a large portion of available CPU cycles to I/O data transfers, and the latency for all types of tasks increased with the decrease in available CPU cycles. However, from the standpoint of security, the initial I/O data transfer method, illustrated in FIGS. 1B-D, afforded to a system designer the opportunity for highly secure I/O data transfer using the CPU's memory management unit to protect the destination of the WRITE. In such systems, the CPU is directly involved in the transfer of each word, or unit, of data, and initiates all I/O data transfers. Moreover, only the CPU initiates READ and WRITE operations directed to system memory. With appropriate operating system implementation in conjunction with the CPU memory management unit, I/O data transfers can be restricted to read from, and write to, specific portions of system memory 120.

The performance bottleneck caused by direct CPU intervention in each word-sized I/O data transfer motivated system designers to introduce DMA engines into systems to manage I/O data transfer, offloading much of the processing overhead of I/O data transfers from the CPU to the DMA engine. FIGS. 2A-D illustrate a direct-memory access (“DMA”) method for facilitating and controlling I/O data transfer. Comparing FIG. 2A to FIG. 1A, it can be seen that a DMA processing functionality 202 is introduced into the I/O controller, represented in FIG. 2A as a box within the microprocessor. This functionality is implemented as software or firmware that executes on the microprocessor 118. The DMA processing functionality 202 may be referred to as a “DMA engine.” In the majority of modem systems, DMA engines are included in various other system components, including I/O controllers. Thus, in modem systems, multiple DMA engines are employed. Regardless of how many DMA engines are present, and where the DMA engines are located, DMA engines allow for direct, DMA-mediated I/O data transfers by external devices, such as I/O controllers, to main memory 106 and for participation by external devices in the system bus 108 cache protocol and the CPU caches 104.

A READ operation carried out using DMA-mediated I/O data transfer is illustrated in FIG. 2B-D. First, as shown in FIG. 2B, the CPU 102 initiates the READ operation by controlling signal lines of the system bus 108 to send a READ message to the disk-drive controller 112, as in the previous method shown in FIG. 1B. Next, in FIG. 2C, the disk-drive controller 112 accesses the disk-drive 110 to fetch successive blocks of stored data. Finally, as shown in FIG. 2D, the disk-drive controller 112 transfers the data, under control of the DMA functionality 202, to main memory 106. Following completion of the READ operation, the disk-drive controller may return a READ completion acknowledgment to the CPU 102.

DMA-mediated I/O data transfer offloads an enormous amount of processing from the CPU, and even low-end, modern computers generally employ a number of cascaded DMA engines in order to preserve sufficient CPU processing cycles for modern system needs. However, unlike in the original I/O data transfer method, illustrated in FIGS. 1A-D, the processor's memory management unit is no longer involved with access to main memory. Instead, an I/O controller may initiate, via the DMA engine, READ or WRITE operations directed to main memory. This direct access by a processing element external to the CPU constitutes a significant security vulnerability. For this reason, designers, manufacturers, and users of computer systems, and, particularly designers of secure computer systems, have recognized the need for a method and system that allows offloading I/O-data-transfer processing from one or more CPUs of a computer system, but that does not expose portions of memory containing confidential information to processing elements external to the CPU.

### SUMMARY OF THE INVENTION

One embodiment of the present invention allows a secure processing entity within a computer system to allocate a portion of a system resource for use only by the secure processing entity, and to protect the allocated portion of the system resource from DMA-access by an I/O controller's DMA engine in a manner which allows the I/O controller to be controlled by untrusted software entities. In one embodiment, a secure kernel may configure a bus bridge or system controller to return an invalid-memory-address error to any DMA engine attempting to access that portion of the system memory intended for exclusive use by a secure kernel.

### BRIEF DESCRIPTION OF THE DRAWINGS

FIGS. 1A-D illustrate an initial approach employed within computer systems to transfer data back and forth between internal memory and mass storage devices and communications devices.

FIGS. 2A-D illustrate a direct-memory access method for controlling I/O data transfer.

FIGS. 3A-B illustrate an approach to designing a secure computer system.

FIGS. 4A-B illustrate conceptual boundaries of the secure platform kernel and secure platform global services software layer and underlying hardware.

FIG. 5 illustrates, in abstract fashion, acquisition of a view of system memory by a system controller.

FIG. 6 illustrates address translation within some types of bus bridges and/or system controllers.

FIG. 7 illustrates address translation via one type of an address-translation table.

FIGS. 8A-B illustrate two different types of system memory views maintained by a system controller or bus bridge that are employed in certain embodiments of the present invention.

FIG. 9 illustrates a number of embodiments of the present invention.

FIG. 10 is a flow-control diagram of the process by which the secure platform kernel or secure platform global services components of the secure computer system can secure protected memory for exclusive use by the secure kernel.

### DETAILED DESCRIPTION OF THE INVENTION

The present invention relates to methods, and systems using the methods, for maintaining secure system control over system memory and other system resources while, at the same time, offloading I/O-data-transfer processing from system processors to I/O-controller DMA engines. Embodiments of the present invention employ features of currently existing I/O bridge and system controllers, including memory-sizing registers and internal address-mapping tables, to prevent access to protected portions of system memory by untrusted software directly controlling I/O-controller DMA engines. The method of the present invention can be employed in a wide variety of computer systems, but may be particularly usefully employed in new generations of secure computer systems currently under design. The design for one, new-generation secure computer system that can be implemented using the Intel IA-64 processor architecture, and other modem processor architectures that provide similar features, is described in U.S. patent application Ser. No. 10/118,646, filed on Apr. 8, 2002 by Worely et al. (“Worely”), assigned to the same assignee as the current application, hereby incorporated by reference within the current application.

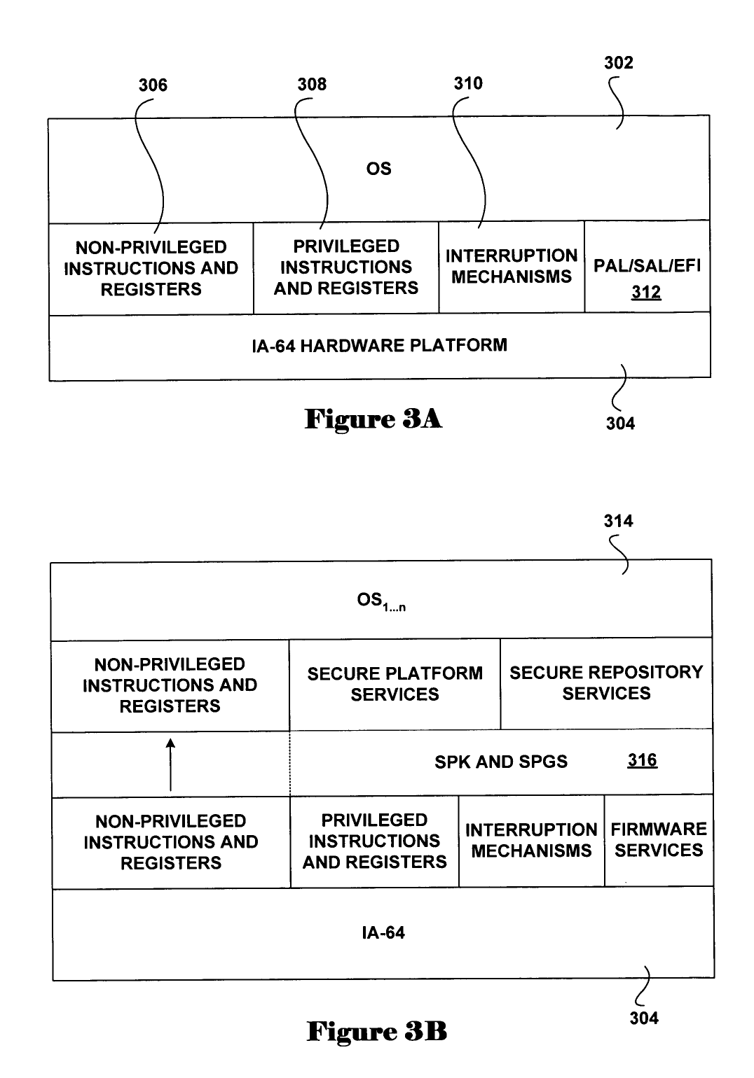

FIGS. 3A-B illustrate an approach to computer system security described in Worley. In a traditional computer system, as shown in FIG. 3A, an operating system 302 is layered directly onto a hardware platform 304. In this case, the hardware platform is the IA-64 processor architecture with an interface that includes non-privileged instructions and registers 306, privileged instructions and registers 308, interruption mechanisms 310, and a firmware interface 312, along with many other hardware components to which one or more IA-64 processors interface directly or indirectly. In the new, secure-system architecture disclosed in Worley, one or more operating systems 314 interface to a secure-platform kernel (“SPK”) and secure-platform global services (“SPGS”) software layer 316, referred to below as the “SPK/SPGS layer” or as the “secure kernel,” which, in turn, interfaces to the IA-64 processor architecture 304. The SPK/SPGS layer 316 shields and protects all but the non-privileged instructions and non-privileged registers of the underlying hardware architecture from access by operating systems and higher-level software programs and utilities. The SPK, by exclusively interfacing to the privileged instructions and registers, interruption mechanisms, and firmware services interfaces, maintains exclusive control over internal system resources. Of course, an operating system running on top of the SPK may access memory, may create operating-system-specific memory-based data structures, and may direct device drivers to carry out I/O, but the operating system only has access to certain portions of system memory and other resources, and cannot access the entire memory. This allows the SPK to maintain confidential information in memory, including encryption keys and passwords, that cannot be accessed by an operating system, third-party applications or controllers, and/or other processes and computing entities.

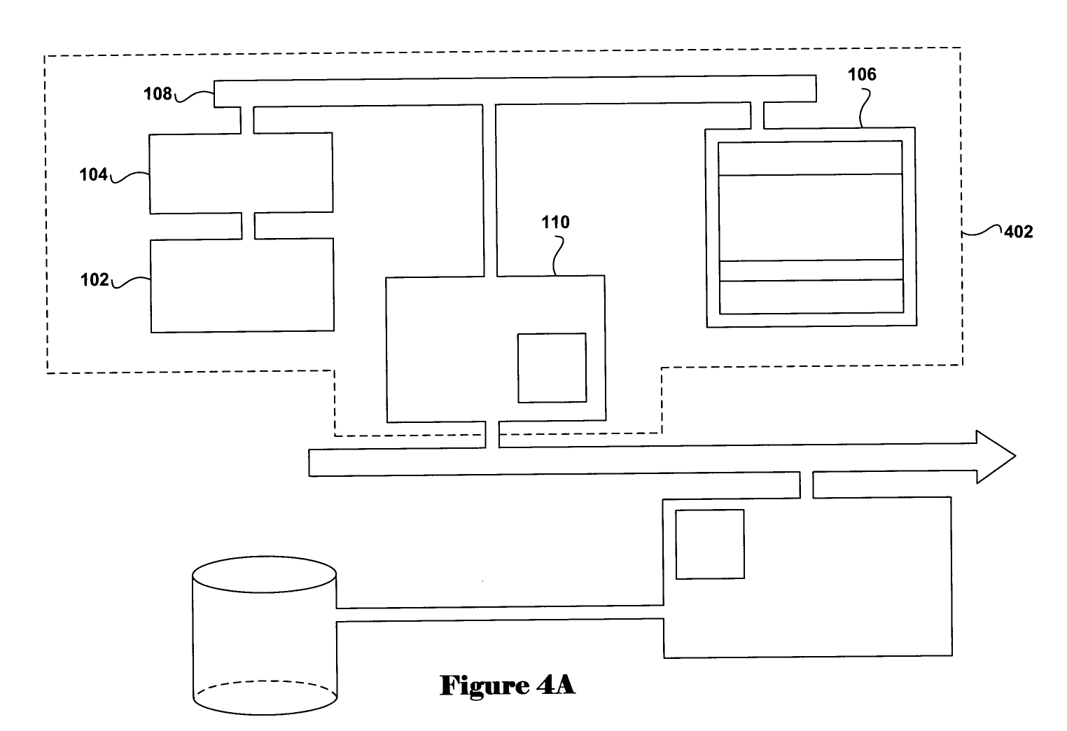

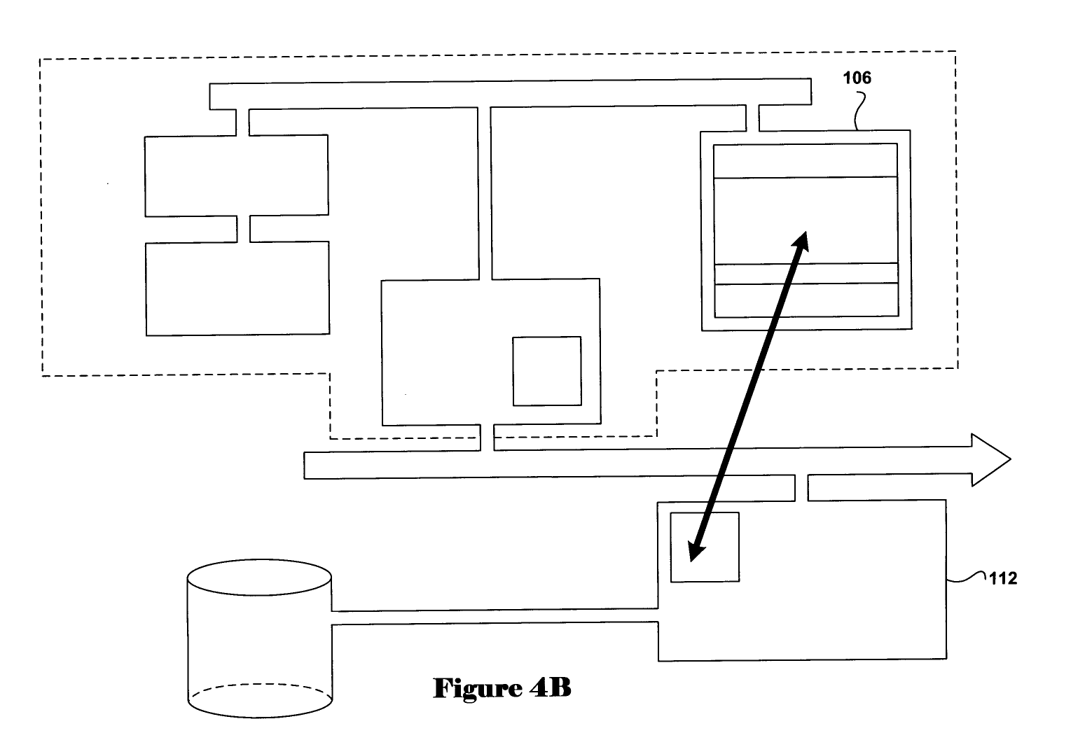

FIGS. 4A-B illustrate conceptual boundaries of the SPK/SPGS layer and underlying hardware. In FIG. 4A, a dashed line 402 encloses the CPU 102, cache memory 104, main memory 106, system bus 108, and system controller 110. This dashed line encloses internal system resources under the exclusive control of the SPK/SPGS layer (316 in FIG. 3B). In order to ensure a secure system, a device not controlled directly by the SPK/SPGS layer cannot be allowed to directly control components within the group of components surrounded by the dashed line 402. However, as shown in FIG. 4B, the presence of the DMA-mediated I/O-data-transfer mechanism, described above, directly violates the necessity for exclusive control of internal system resources, most particularly system memory, by the SPK/SPGS layer. As seen in FIG. 4B, and discussed above, the DMA engine provides a means for an I/O controller, such as disk-drive controller 112, to directly access main memory 106. In the absence of the mechanisms of various embodiments of the present invention, described below, unintended software or hardware flaws or intentional Trojan-horse-like software agents in components accessing memory through the I/O controller's DMA engine may provide access to protected memory outside of the security constraints, and without detection by, the secure kernel. Were it possible to extend the boundaries of SPK control to the I/O controllers, or equivalently, to extend the dashed line in FIG. 4A to encompass both the I/O bus and the disk-drive controller, then the fact that the disk-drive controller's DMA engine can directly access system memory would not necessarily constitute a potential security risk, providing that disk-drive controller software and hardware were properly verified for correct operation, or, in other words, providing that the disk-drive controller software and hardware were “trusted.” Unfortunately, it is not currently practical to insist that all I/O controllers within the system be proprietary controllers developed and manufactured according to standards required by the secure-computer-system designers. Practically, the manufacturer of a secure computer system must be able to incorporate unverified, third party I/O controllers, and other untrusted third party processing entities, such as operating systems and device drivers, into a secure system.

A third party I/O controller may also not necessarily constitute a security risk. However, it is common for I/O controller software, as with all software, to include inadvertent and unforeseen problems and errors, and any of these unforeseen problems and errors may result in improper access of system memory and other internal system resources and/or corruption of system memory and other system resources. For example, the system memory of a secure computer system may store a number of highly confidential data, including encryption keys and system information and control values. A misdirected and erroneous system-memory READ initiated by the disk-drive controller may result in reading highly confidential information from a region of system memory intended for use only by a secure kernel. The erroneously read, but highly confidential, information may then end up being transferred by the I/O controller from system memory to a file on the disk-drive that may then, in turn, be inadvertently accessed, revealing the highly confidential information to the accessing entity. Similarly, an inadvertent and erroneous system-memory WRITE initiated by an I/O controller via a DMA engine may result in corruption of system memory, introduction of security breaches, and even catastrophic failure of the secure computer system.

Even more worrisome are intentional and malicious I/O-controller control programs. Such program may take advantage of the direct access to system memory via DMA engines to surreptitiously search system memory for desired confidential information and export that information outside of the secure computer system. Similarly, malicious software may alter system memory in order to construct security breaches through which third parties can access or control the secure system. In a secure computer system, even operating systems and device drivers that execute above the secure kernel are generally untrusted, and represent potential security breaches.

For the above reasons, the necessity of incorporating third party I/O controllers, third party operating systems and device drivers, and other such untrusted processing elements within a secure computer system, combined with the presence of DMA-engine-facilitated direct access by I/O controllers to system memory, represents a serious security issue that must be addressed in secure system design. In the SPGS/SPK secure system described above, for example, one or more operating systems execute within the system almost as if they each were running directly above the machine hardware. The SPGS/SPK, by design, does not monitor operating system activities, or attempt to verify operating system commands and processes at run time. Instead, the operating system is allowed to control most machine resources as if no SPGS/SPK layers were interposed between the operating system and the machine hardware. An operating system is thus allowed to interface with, and control, many different resource-accessing devices.

Ultimately, secure-computer-system manufacturers may be able to provide and enforce standards for third party software, and verify that the third party software meets those standards, in order to ensure that I/O controllers do not contain either inadvertent errors or malicious programs. However, that approach is currently not commercially feasible, and ultimate feasibility is not yet determinable. It may also be possible to develop secure DMA engines for secure systems that monitor and filter commands received from untrusted processing entities in order to filter commands that would result in access to SPK-controlled resources and other resources outside those specifically allocated to the untrusted processing entities by the SPK. However, such DMA engines are not currently available, although the need for secure systems is currently quite high. Therefore, a different approach is needed, at least in the interim, to secure the security breach illustrated in FIG. 4B and secure the conceptual boundaries of the SPK/SPGS layer and underlying hardware, illustrated in FIG. 4A, using currently available hardware devices and untrusted processing entities.

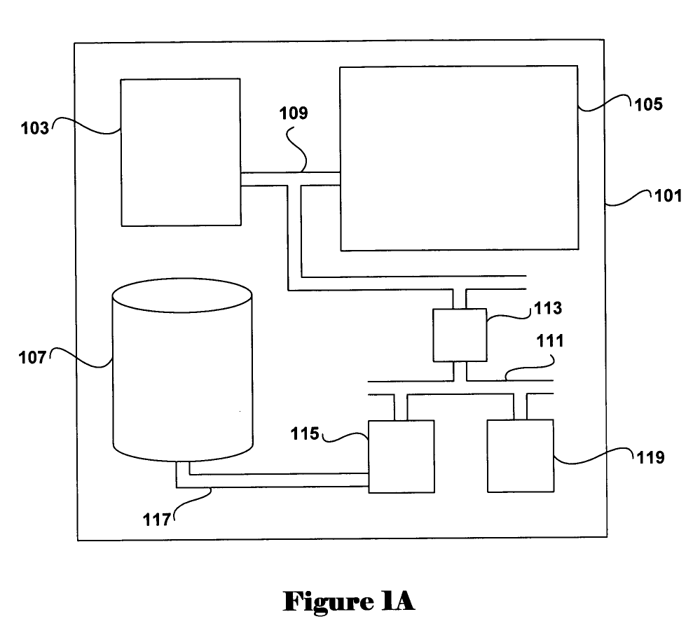

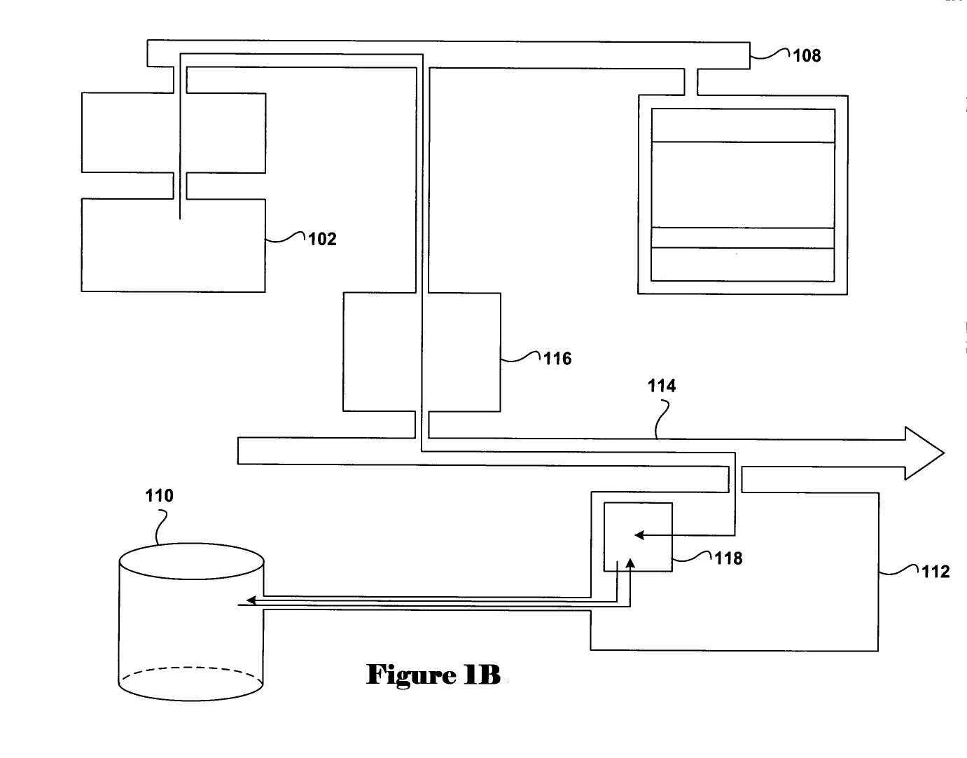

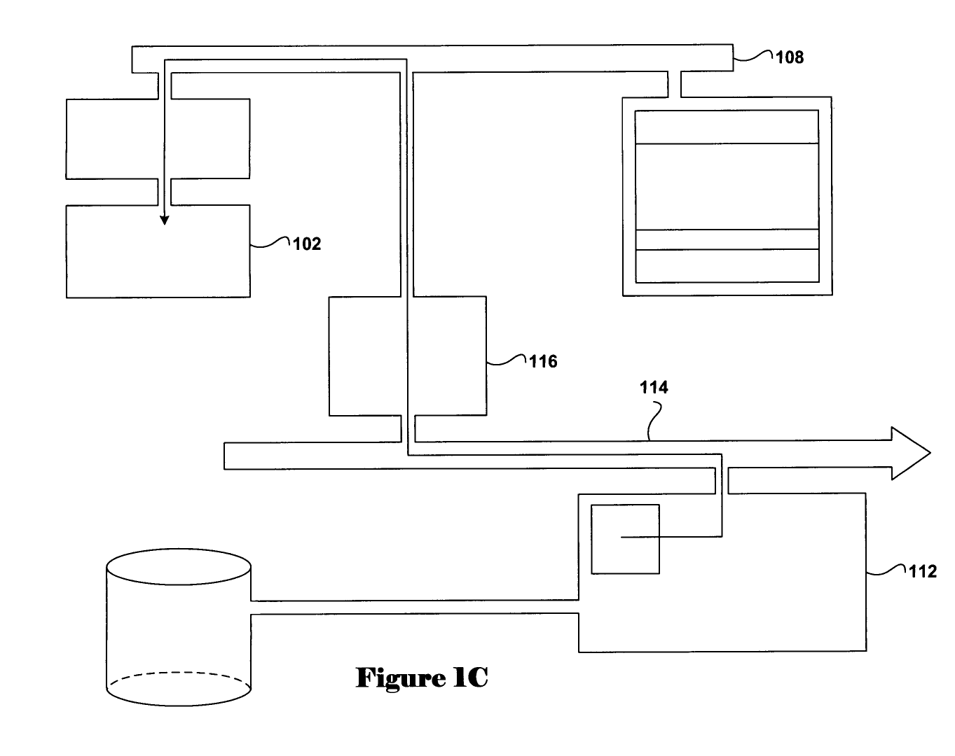

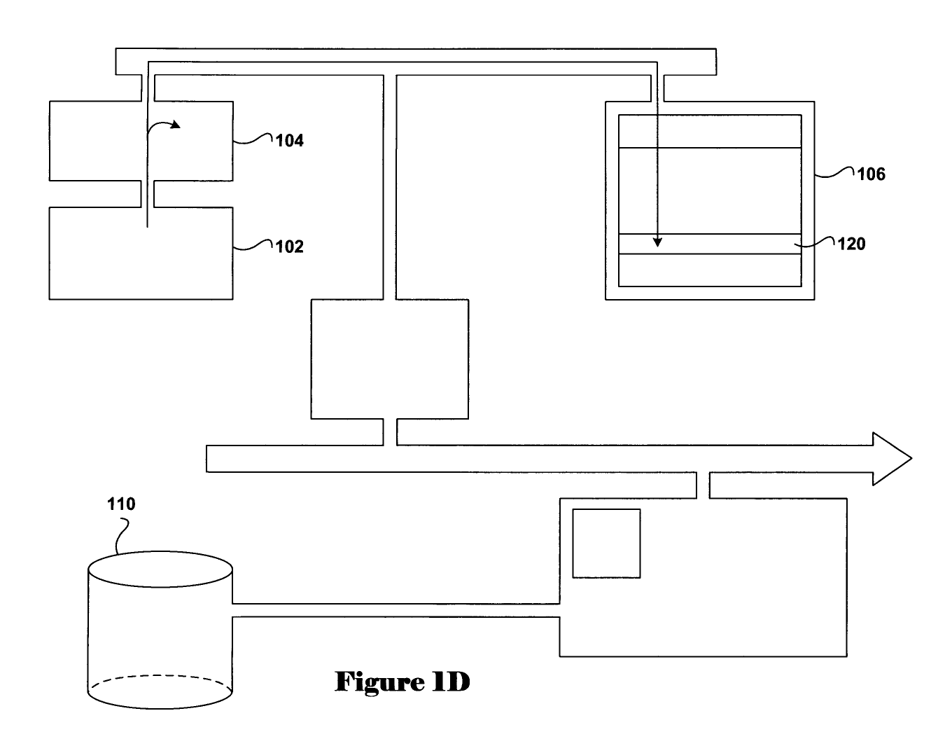

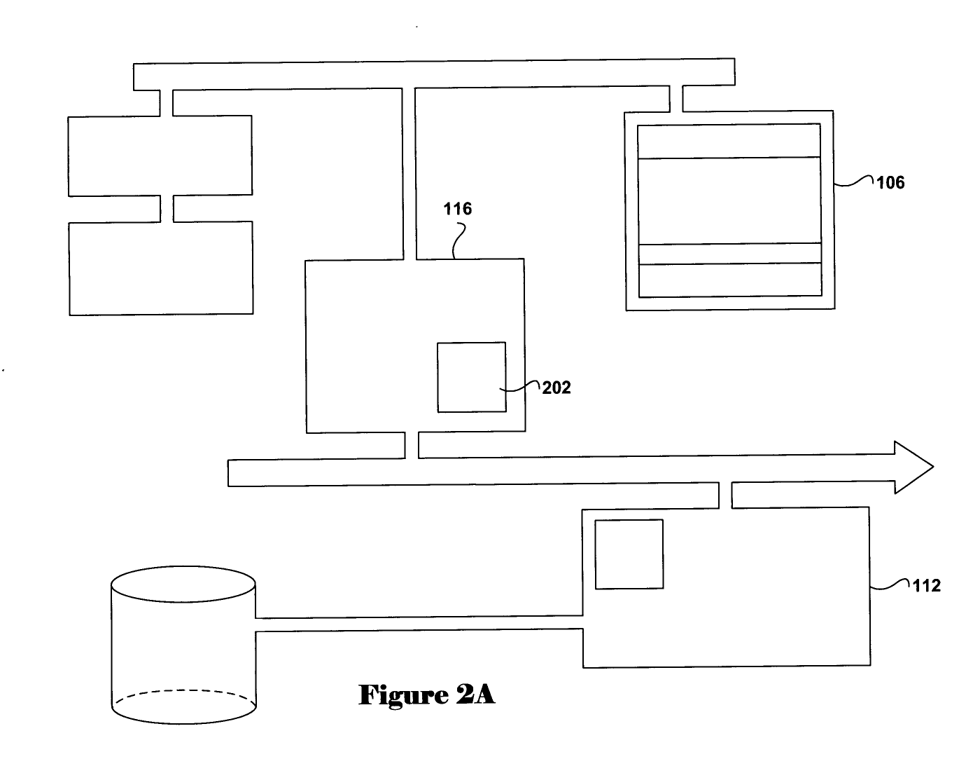

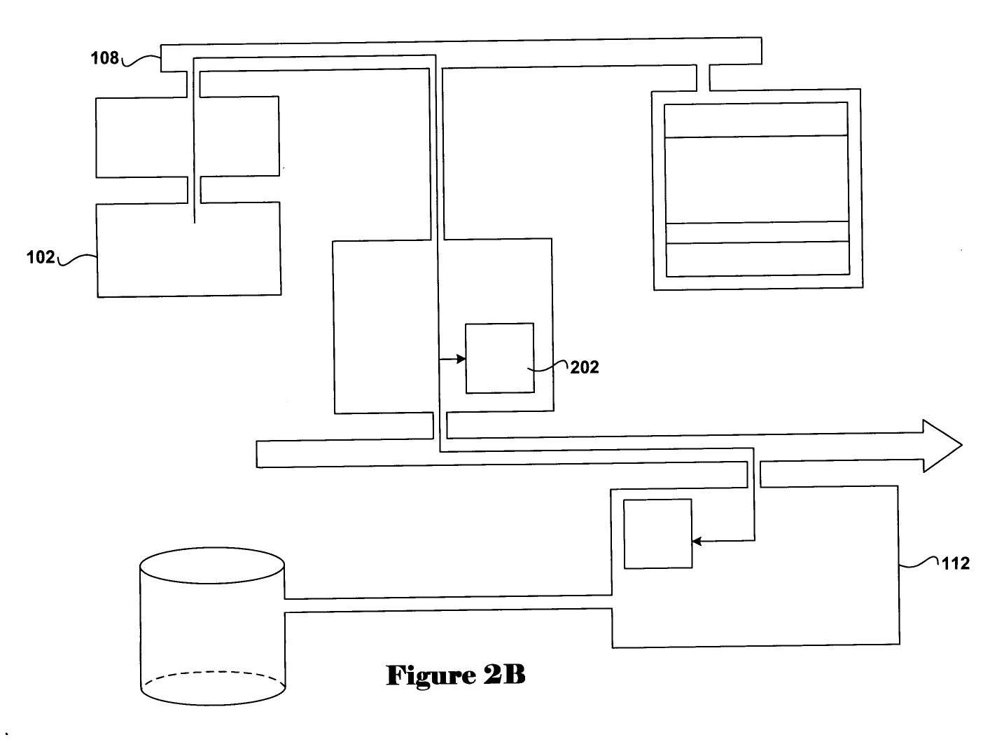

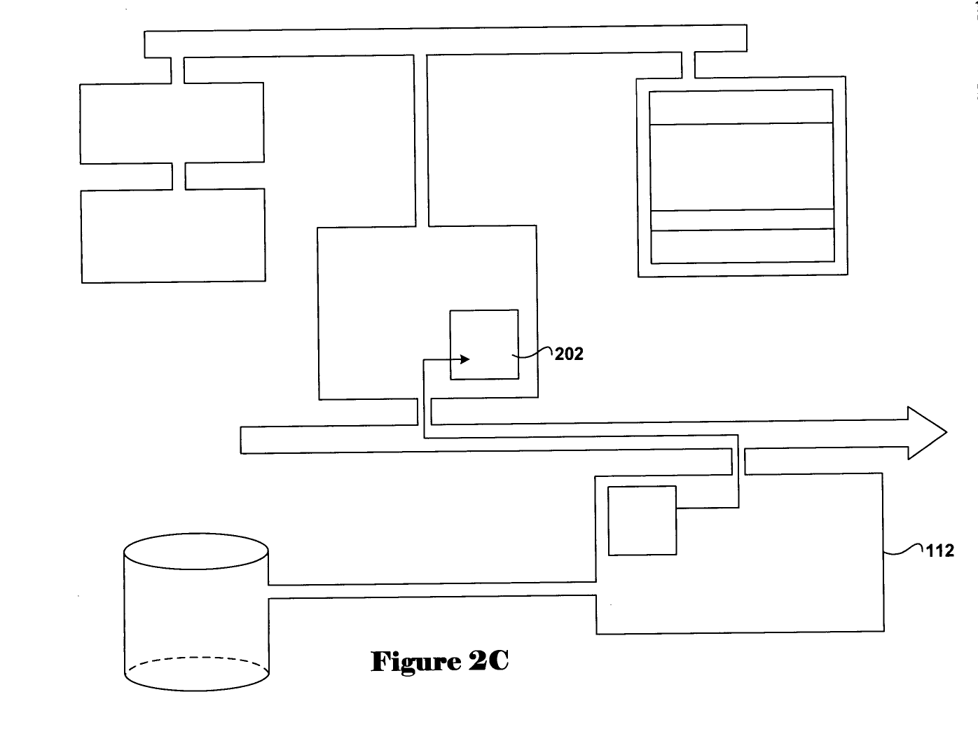

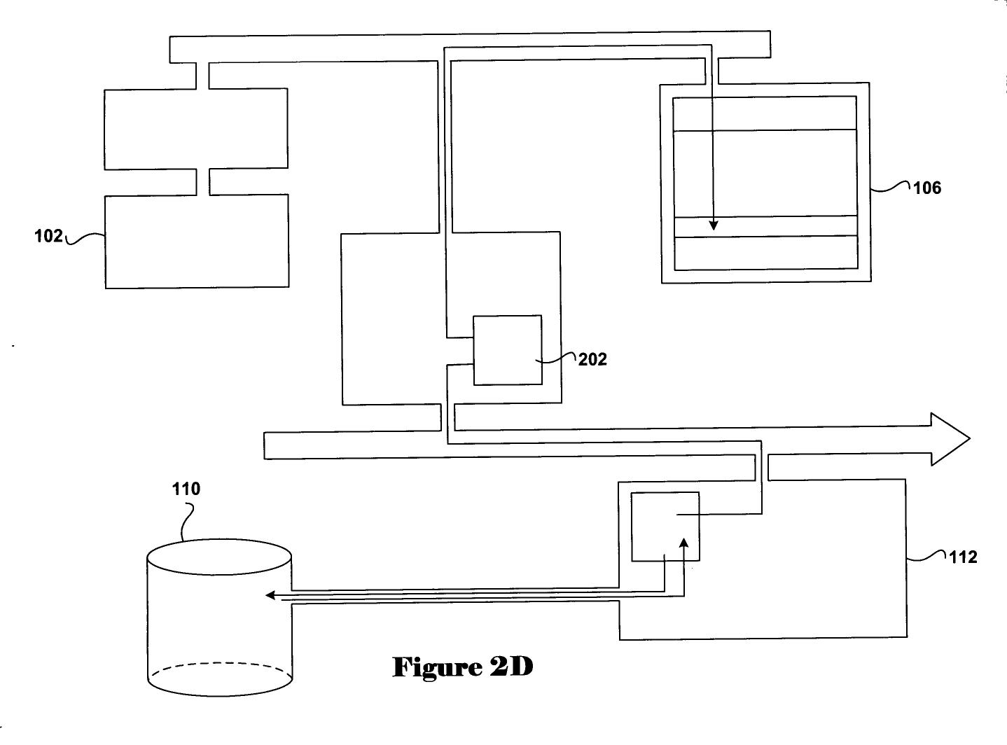

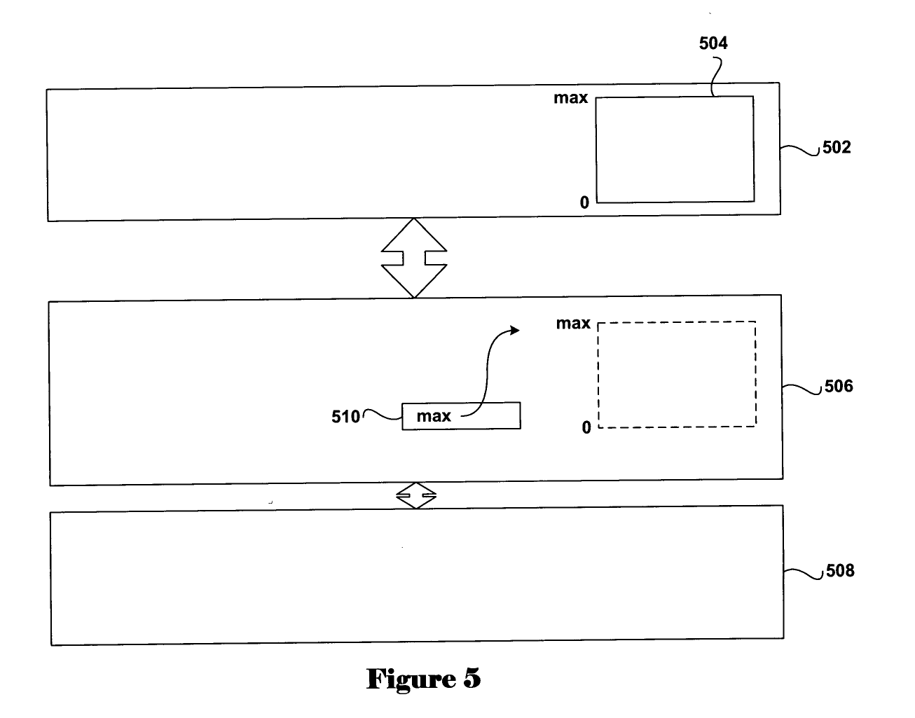

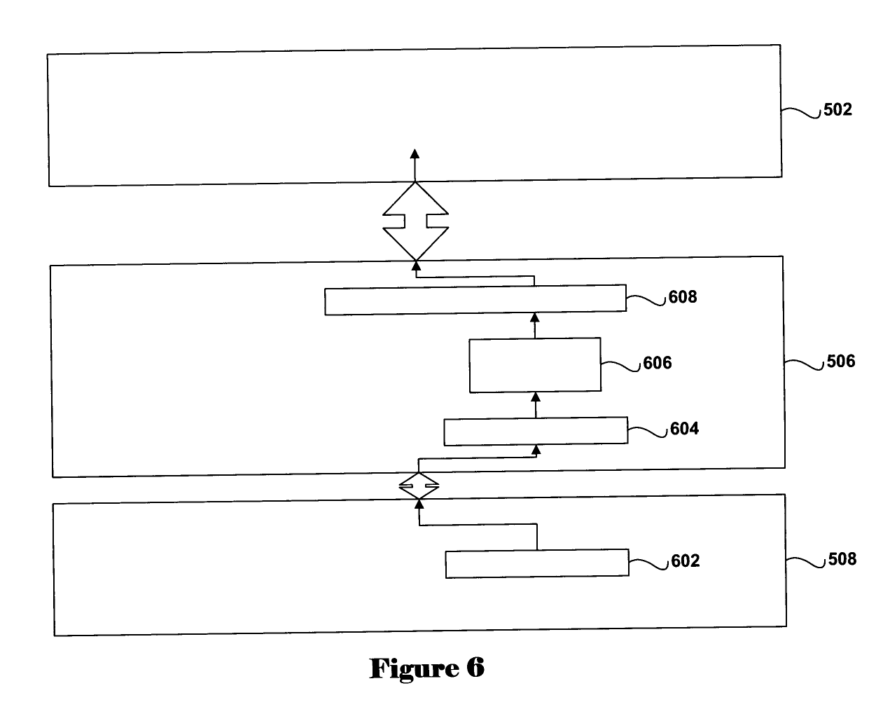

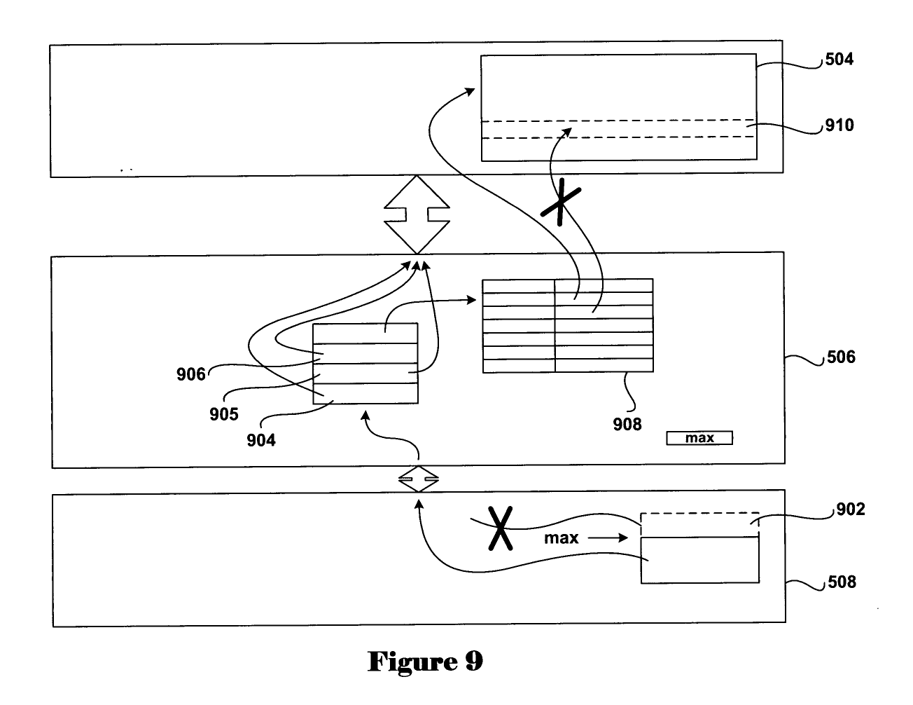

In general, a system controller or I/O bridge needs to acquire a view of system memory in order to be able to sensibly direct READ and WRITE operations to system memory. Commonly, an operating system or initialization firmware, in the case of traditional computer architectures, writes one or a few registers within the system controller that describe the maximum memory address supported by system memory. FIG. 5 illustrates, in abstract fashion, acquisition of a view of system memory-by a system controller. In FIG. 5, as in FIGS. 6 and 9, discussed below, the system components illustrated in FIGS. 1A-D, 2A-D, 3A-B, and 4A-B, are more abstractly represented in terms of the following blocks: (1) internal secure-system resources 502, including system memory 504; (2) a bus bridge and/or system controller and I/O bus 506; and (3) an I/O controller 508. Relatively abstract, high-level block diagrams are employed to illustrate the following discussion because there are myriad different I/O controllers, system controllers, bus bridges, and system-resource interfaces, all with quite different low-level details. This discussion is intended to present the concepts that underlie the widely varying implementations.

As shown in FIG. 5, system memory 504 contains a fixed amount of memory, often many gigabytes of addressable memory space. Because different systems may have system memories of different sizes, and because system memory can generally be expanded by adding memory modules to the system, the system controller or bus bridge 506 does not contain a static indication of the size of system memory, but instead includes a register 510 that an operating system can write to indicate the size of system memory, in bytes or words, or, equivalently, the maximum allowed system memory address, generally one less than the maximum system memory size, since memory addresses start with address 0. The system controller can then reject requests to access memory addresses greater than the indicated maximum memory size stored in the register 510. Thus, the system controller or bus bridge acquires a view of system memory via the system-memory size stored in the system-memory-size register.

FIG. 6 illustrates one means of address translation within a bus bridge or system controller. In FIG. 6, an address 602 has been constructed within the I/O controller 508. The system controller transmits the address 602 to the bus bridge or system controller 506 during the course of initiating an I/O data transfer. Within the bus bridge or system controller, the address transmitted by the I/O controller 604 is input to an address-translation mechanism 606 that converts that input address 604 into a translated address 608 that may be output to internal system resources. Note, for example, that the output address may be longer, or differently formatted, than the input address. The output address is then transmitted by the bus bridge or system controller to internal resources of a computer system 502, and can be used, as well, by other components within the bus bridge and system controller.

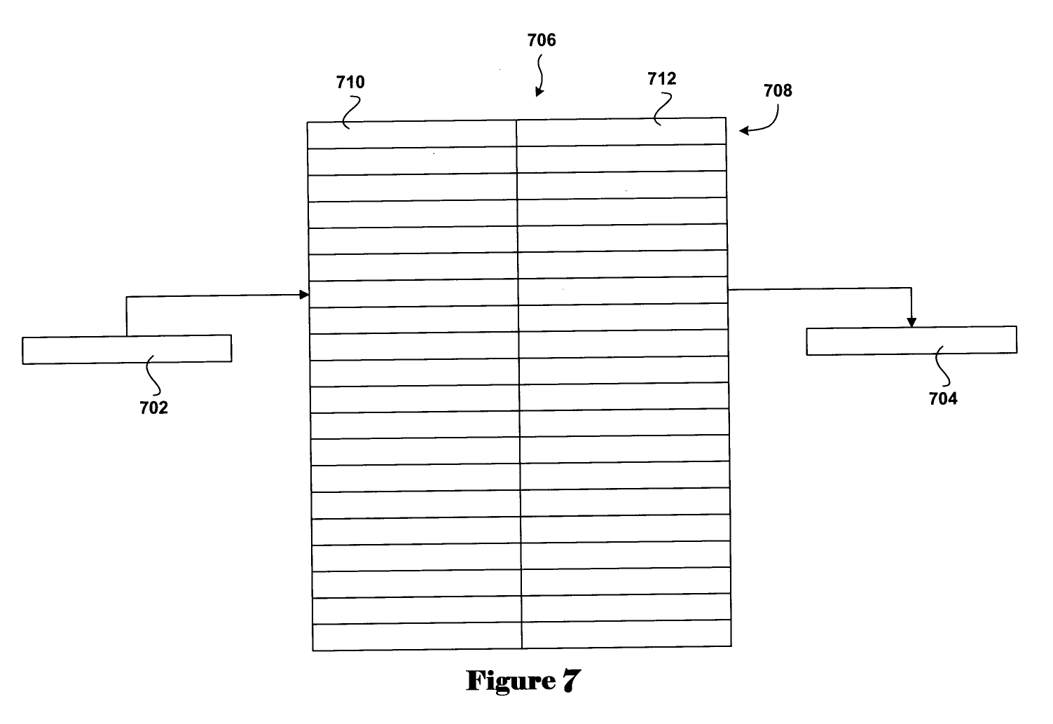

There are many different possible address-translation mechanisms that can be used within a bus bridge or system controller. FIG. 7 illustrates address translation via an address-translation table. Address translation involves transforming at input address 702 to an output address 704. In general, an address-translation table 706 stores address translations, with each row, such as row 708, in the address-translation table corresponding to a single address translation. The address translations may comprise an input address 710 paired with an output address 712. The address-translation operation then involves searching the address table for an address-table entry, or address translation, with an input-address field storing the value matching the input address 702, and outputting the contents of output-address field 712 to the output address 704. There are many variations of this mechanism. For example, the address table may be page based, so that only a portion of the input address is used as a page address to locate a corresponding page-address value in an address translation within the address table. In this case, the address translation contains an output page address which can be combined with a page offset extracted from the input address to form a final, translated, output address. In some cases, the address table may be indexed by input page address so that address-table entries need only contain a single field. In this case, the single field contains the output page address corresponding to the page-address index of the address-table entry.

In many cases, only certain ranges of input addresses are subject to address translation. Addresses outside this range are passed through unmodified. However, as long as those addresses subjected to translation can be securely prevented from being generated on the system bus, barring an identity translation in the table, then a range of memory addresses is protected from access by I/O-controller DMA engines. As a consequence, SPK must be in control of setting up the address translations to prevent identity mappings.

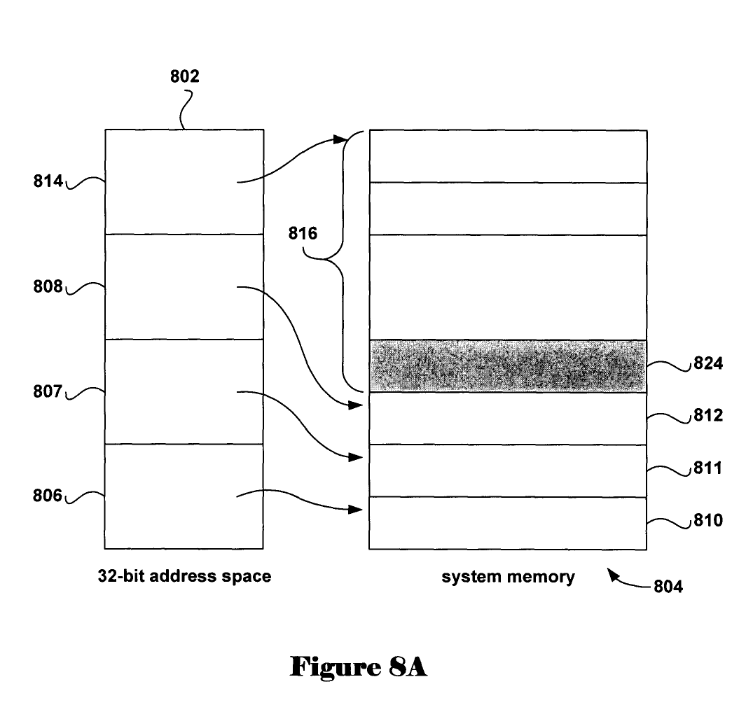

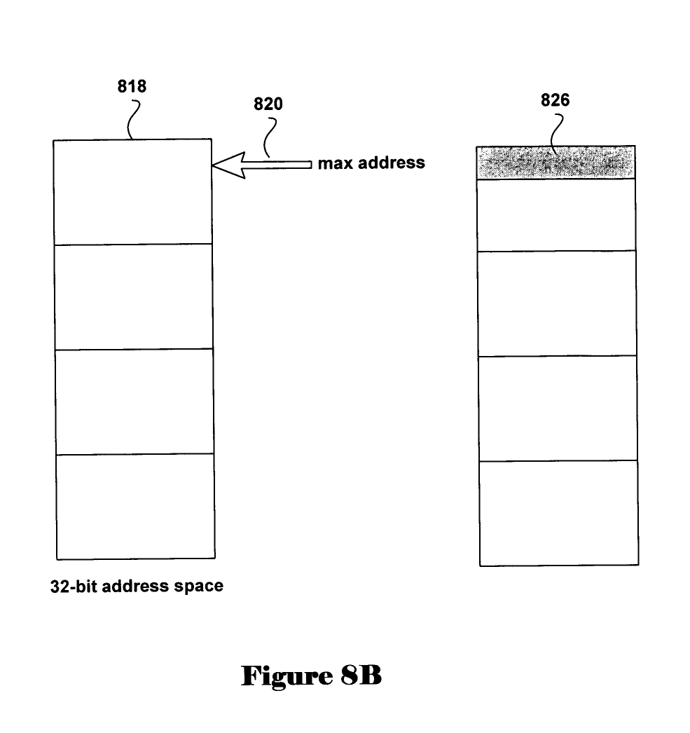

FIGS. 8A-B illustrate two different types of system memory views maintained by a system controller or bus bridge that are employed in certain embodiments of the present invention. In FIG. 8A, a view based on address translation, described above with respect to FIGS. 6 and 7, is employed within a system controller or bus bridge to map certain 32-bit addresses logically specifying memory locations within a 32-bit address space 802, received via an I/O bus from I/O device controllers, to higher-addressed regions of system-memory address space 804. In one commonly used approach, the addresses of the first 3 Gbyte regions 806-808 of the 32-bit address space 802 are directly mapped to the first 3 Gbytes 810-812 of system memory address space. The highest-order Gbyte portion of the 32-bit address space 814 is used like a window into the generally vastly larger, higher-than-3-Gbyte region of system-memory address space 816. By remapping highest-order 32-bit-address-space addresses using address translation tables within the system controller, the highest-order-address-space addresses can be mapped to any of the higher-than-3-Gbyte system-memory-address-space addresses. As long as SPK controls the creation of such mappings, SPK can protect a portion of memory within that higher-that-3-Gbyte system-memory-address-space. In FIG. 8B, a view of system memory based on setting, by an operating system or secure kernel, the maximum-system-memory-address register, or equivalent, of a system controller to point to an address 820 within a 32-bit-memory-address-space 818 address less than the maximum 32-bit address 0×FFFFFFFF. This allows I/O device controllers to generate 32-bit addresses targeting system memory up to the address specified in the maximum-system-memory-address register, and causes the system controller to trap an out-of-bounds memory address rather than attempt to access a non-existent address. As long as SPK controls the contents of this register, SPK can protect that portion of memory above the max value setting. Of course, the above example is not meant to restrict embodiments of the present invention to 32-bit addressing. Embodiments of the present invention can be implemented in systems supporting any address-space size and addressing granularity.

One aspect of the present invention is the recognition that the address-translation and maximum-address-specification features of system controllers and I/O device controllers, designed and used for providing full access by I/O devices to system memory, can be used, instead, to protect regions of system memory from intentional or unintentional access, via DMA engines, by external entities, such as I/O device controllers and processing entities that interact with the I/O device controllers. In other words, features designed and used to provide maximum access to system-memory address space can be employed to obtain a contrary result. For example, in FIG. 8A, if the address translations loaded into the address table of the system controller are invariably directed to system-memory-address-space regions outside of a special, protected region, then external I/O device controllers and other external entities that use DMA engines cannot access the special, protected region. For example, the first three GBytes 806-808 of 32-bit address space are directed without translation to the first three Gbytes of system-memory address space 810-812. Only the highest-order Gbyte of 32-bit address space can be translated by the address-translation mechanism of the system controller to system-memory address space. By providing only address translations directed to system-memory address space above 4 Gbytes, a 1 Gbyte protected, or shadow, region 824 of system-memory address space is obtained that is inaccessible to external devices accessing system memory through the system controller. Similarly, by setting the maximum-address register within a system controller to an address lower than the actual maximum address supported by system memory, a protected, or shadow, region 826 of system-memory address space is obtained that is inaccessible to external devices accessing system memory through the system controller. In general, the protected, or shadow, region of system-memory address space corresponds to a region of physical system memory.

FIG. 9 illustrates a number of embodiments of the present invention. Although it is not currently possible for secure-computer-system designers to ensure that only trusted, third party I/O controllers are incorporated into secure systems, secure-computer-system designers may employ either or both of the system-controller features described above, with reference to FIGS. 5-8, to prevent direct access by I/O controllers to a protected, or shadow, region of system-memory address space. In a first embodiment, a secure kernel assumes direct control of system-controller or I/O bridge initialization, with operating systems and other untrusted entities required, if allowed at all, to access system-controllers through an interface provided by the SPK/SPGS layer. The secure kernel allocates a high-order portion of 32-bit system-memory address space for exclusive use by the SPK/SPGS, and initializes each system controller with a maximum-supported-system-memory address lower than the lowest portion of system memory allocated for exclusive use by the secure kernel. Thus, as shown in FIG. 9, the I/O device controller 508 cannot issue memory-access operations to the system controller directed to a shadow region 902 of the available system-memory address-space. An attempt by the I/O controller to access an address in the shadow region results in return, by the system controller, of an out-of-bounds memory-access error. In a second embodiment, the secure kernel also assumes direct control of the I/O system controller or controllers, with operating systems and other untrusted entities required to access the system controllers, if allowed at all, through an interface provided by the SPK/SPGS layer. The secure kernel allocates a high-order portion of 32-bit system-memory address space for exclusive use by the SPK/SPGS, and does not provide any address translations to the system controller directed to the portion of system-memory address space allocated for exclusive use by the secure kernel. As shown in FIG. 9, addresses from the lowest regions of an address space available to I/O device controllers 904-906 are passed through directly and untranslated to the system bus and system memory by the system controller, while high-order addresses are passed through address translation 908, which translates the high-order addresses to system-memory addresses outside the portion of system-memory address space allocated for exclusive use by the secure kernel, or optionally to non-existent addresses which other controllers such as the memory controller flag as an out of bounds memory access. Thus, any attempt by an I/O device controller to access protected system memory through the system controller or bus bridge is deflected, via address translation, to unprotected system memory, or caught as an error. In a third embodiment, both of the above-described methods can be concurrently employed. System controllers are provided only with address translations directed to regions of system-memory address space outside the portion of system-memory address space allocated for exclusive use by the secure kernel, and systems controllers are also initialized with maximum-available-system-memory-address values lower than the first address within a protected region of high-order address-space.

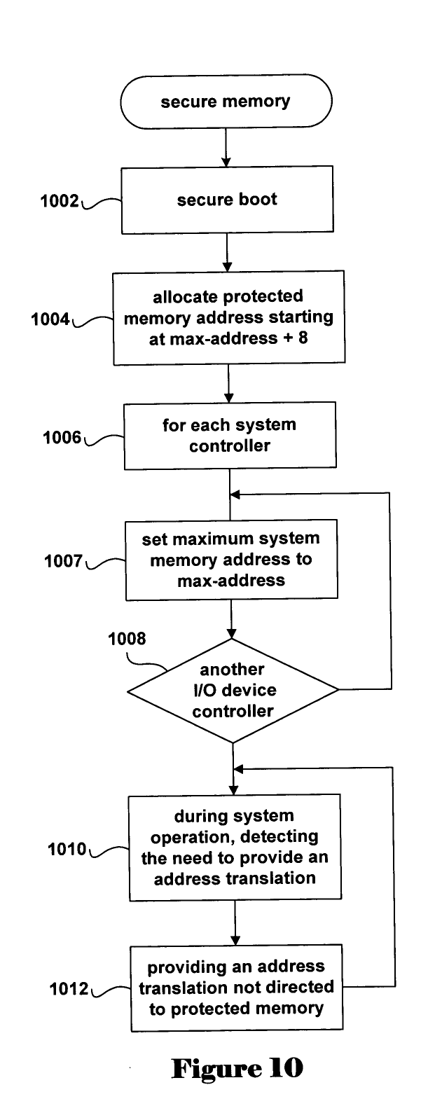

FIG. 10 is a flow-control diagram of the process by which the secure platform kernel or secure platform global services components of the secure computer system can secure protected memory for exclusive use by the secure kernel according to the above-described third embodiment. In step 1002, the secure platform kernel undertakes and completes a secure boot procedure, details of which are disclosed in Worley. Next, in step 1004, the secure platform kernel allocates a region of system-memory address space for exclusive use by the secure kernel, with a starting address greater than a maximum address that the secure kernel will use for initializing system controllers. In the for-loop of steps 1006-1008, the secure kernel initializes each system controller with the maximum address obtained in step 1004. Finally, during system operation, when the SPK/SPGS fields an interface call resulting in a need to furnish an address translation to a system controller, in step 1010, the SPK/SPGS provides to the system controller an address translation not directed to the protected memory. Note that either of steps 1006-1008 or steps 1010-1012 may be separately employed to protect system memory, according the first and second embodiments, described above.

Although the present invention has been described in terms of a particular embodiment, it is not intended that the invention be limited to this embodiment. Modifications within the spirit of the invention will be apparent to those skilled in the art. For example, although the above discussion focused on system memory access by I/O controllers via DMA-engine-containing bus bridges and system controllers, the present invention may be used to prevent many different untrusted processing entities from straying beyond the boundaries of portions of system resources allocated to them, including operating systems, device drivers, and other third-party software, hardware, and combined hardware and software entities. For example, addressable system resources other than main memory that may be directly accessed by external devices through bus bridges and system controllers may be protected by the methods of the present invention. The details of bus-bridge and system-controller configuration and address-table manipulation vary from one bus bridge or system controller to another, and an almost limitless number of specific SPK/SPGS layer implementations may be devised to practice the present invention with respect to the many different bus bridges and system controllers. A secure computer system may contain a large number of system controllers and bus bridges, each of which may need to be configured and manipulated according to methods of the present invention. In certain systems, more than one protected system-memory address-space region may be created and maintained by the techniques of the present invention by a secure kernel, using additional system-memory-address-space-view-creation mechanisms of system controllers, such as additional memory-address-bounds registers.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for passing control of a system-resource-accessing device, which accesses a system resource through system-resource addresses, to an untrusted entity within a secure computer system having a secure kernel without passing control of the entire system resource to the untrusted entity, the method comprising:
assuming control of address-translation provision to system controllers within the computer system by the secure kernel;
allocating a specific portion of the system resource for exclusive access by the secure kernel; and
during system operation, providing, by the secure kernel, address translations to the system controllers that are not directed to the allocated portion of the system resource for exclusive access by the secure kernel.

2. The method of claim 1 wherein the system resource is a system memory, and wherein system-resource addresses are system-memory addresses.

3. The method of claim 2 wherein a portion of the system-memory address-space available to I/O device controllers through the system controllers is commonly translated by an address-translation mechanism within the system controllers to higher-order portions of the system-memory address space, and wherein the specific portion of system-memory address space allocated for exclusive access by the secure kernel is within the portion of the system-memory address space available to I/O device controllers commonly translated by an address-translation mechanism within the system controllers to higher-order portions of the system-memory address space.

4. The method of claim 1 wherein the system-resource-accessing device is one of:
a direct-memory-access engine within an I/O device controller; and
direct-memory-access logic encoded within software, firmware, or a combination of software and firmware executed on a microprocessor within a I/O device controller.

5. A computer system including a secure kernel that maintains a specific portion of a system resource for exclusive access by the secure kernel by the method of claim 1.

6. Computer instructions encoded in a computer-readable memory that implement the method of claim 1.

7. A method for passing control of a system-resource-accessing device, which accesses a system resource through system-resource addresses, to an untrusted entity within a secure computer system having a secure kernel without passing control of the entire system resource to the untrusted entity, the method comprising:
allocating a specific portion of the system resource for exclusive access by the secure kernel;
assuming control over one or more memory-sizing registers of a system controller through which the system-resource-accessing device accesses the system resource; and
setting the one or more memory-sizing registers of the system controller with a view of the system resource that excludes system-resource addresses of the portion of the system resource allocated for exclusive access by the secure kernel.

8. The method of claim 1 wherein the system-resource-accessing device is an I/O device controller.

9. A computer system including a secure kernel that maintains a specific portion of a system resource for exclusive access by the secure kernel by the method of claim 1.

10. Computer instructions encoded in a computer-readable memory that implement the method of claim 1.

11. A secure computer system comprising:
a system resource;
an untrusted processing entity;
a secure kernel that allocates a specific portion of the system resource for exclusive access by the secure kernel; and
a system-resource-accessing device that contains an internal view of the system resource, provided by the secure kernel, that does not include a view of the specific portion of the system resource allocated for exclusive access by the secure kernel, the system-resource-accessing device used by the untrusted processing entity to access only that portion of the system resource corresponding to the internal view of the system resource within the system-resource-accessing device.

12. The secure computer system of claim 11 wherein
the system-resource-accessing device returns an error when the untrusted processing entity attempts to use the system-resource-accessing device to access a portion of the system resource outside of the specific portion of the system resource allocated for exclusive access by the secure kernel.

13. The secure computer system of claim 11 wherein the system-resource is system memory.

14. The secure computer system of claim 11 wherein the system-resource-accessing device is a system controller, and the internal view of system memory comprises address translations that translate memory addresses input to the system controller to system-memory addresses.

15. The secure computer system of claim 11 wherein the system-resource-accessing device is a system controller containing a DMA engine, and the internal view of system memory comprises one or more memory-sizing registers.

16. A secure computer system comprising:
a system resource;
an untrusted processing entity;
a secure kernel that allocates a specific portion of the system resource for exclusive access by the secure kernel; and
a means for accessing the system resource by the untrusted processing entity that does not maintain a view of the specific portion of the system resource allocated for exclusive access by the secure kernel and that therefore does not allow access, by the untrusted processing entity, to the specific portion of the system resource allocated for exclusive access by the secure kernel.
